(19) United States
(12) Patent Application Publication
(10) Pub. No.: US 2003/0120823 A1
(43) Pub. Date: Jun. 26, 2003

(54) Client system for implementing 3-dimensional virtual reality and method for implementing virtual reality using same

(76) Inventors: Sung Ye Kim, Seongnam-si (KR); Bon Ki Koo, Daejeon (KR); Hae-Dong Kim, Daejeon (KR); Byoung Tae Choi, Daejeon (KR)

Correspondence Address: JACOBSON HOLMAN PLLC, 400 SEVENTH STREET N.W., SUITE 600, WASHINGTON, DC, 20004, US

(21) Appl. No.: 10/133,497

(22) Filed: Apr. 29, 2002

(30) Foreign Application Priority Data
Dec. 26, 2001 (KR) 2001-85306

(51) Int. Cl. G06F 9/00

(52) U.S. Cl. 709/310

(57) ABSTRACT

A client system for implementing a 3D virtual reality by using X3D (extensible 3D) data provided from a service server includes an applet, a communication module, and a browsing means. The applet communicates with the service server to receive the X3D data and transmit the received X3D data. The communication module is connected to the applet in order to provide a communication between the service server and a client. The browsing means parses the X3D data received through the communication module to construct a scene graph; conducts a rendering of the scene graph to have a predetermined form; and, then, displays the scene graph on a display window of the client.

### FIELD OF THE INVENTION

The present invention relates to a system for implementing a 3-dimensional virtual reality; and, more particularly, to a client system capable of processing X3D (extensible 3D) data provided from a service server on a real time basis and a method for implementing a 3-dimensional virtual reality by using the client system.

### BACKGROUND OF THE INVENTION

Recent years have seen a rapid development of Internet and its applications, in particular, e-commerce. A service server can provide a service user with a shopping mall environment implemented by using a virtual reality. Thus, a client can shop around or make a purchase on the web by accessing the service server that supports the virtual reality.

A client system on a user's side has required a more real-world-like virtual reality service. Thus, there has been intensified a demand for a system capable of supporting three-dimensional (3D) virtual reality where the service server and the client can interact with each other on a real time basis.

However, conventional client systems cannot satisfy such a current demand because they can only provide a virtual environment based on a two-dimensional image. Researches have yet to develop a technology capable of effectively supporting X3D data, which is expected to be adopted as a standard of 3D visualization technology on the Internet.

### SUMMARY OF THE INVENTION

It is, therefore, an object of the present invention to provide a client system capable of processing extensible (X3D) data delivered from a service server and displaying the processed data on a display device, thereby implementing a 3-dimensationl (3D) virtual reality.

It is another object of the present invention to provide a method for implementing a 3D virtual reality by processing X3D data delivered from a service server and updating a 3D scene on a display device depending on an event occurring in the implemented virtual reality.

In accordance with one aspect of the present invention, there is provided a client system for implementing a 3D virtual reality by using a X3D (extensible 3D) data provided from a service server, including: an applet for communicating with the service server to receive the X3D data and transmit the received X3D data; a communication module connected to the applet for providing a communication between the service server and a client; and a browsing means for parsing the X3D data received through the communication module to construct a scene graph, conducting a rendering of the scene graph to have a predetermined form, and, then, displaying the scene graph on a display window of the client.

In accordance with another aspect of the present invention, there is provided a method for implementing a virtual reality in a client system by using a X3D data provided form a service server, including the steps of: (a) parsing the received X3D data to construct a scene graph; (b) conducting a rendering of the scene graph to have a predetermine form and, then, displaying the virtual reality on a navigation window; (c) updating a scene of the virtual reality according to a user's navigation through the virtual reality displayed on the navigation window; (d) determining whether an event occurs or not in response to an event information in the virtual reality displayed on the navigation window; (e) receiving from the service server a data required for processing the event in the virtual reality based on the event determination and generating an external window to display the received data.

### BRIEF DESCRIPTION OF THE DRAWINGS

The above and other objects and features of the invention will become apparent from the following description of preferred embodiments given in conjunction with accompanying drawings, in which:

FIG. 1 is a block diagram of a client/server system for implementing a 3D virtual reality in accordance with the present invention;

FIG. 2 provides a block diagram of a browser on a client's side for implementing a 3D virtual reality in accordance with the present invention;

FIG. 3 depicts a flowchart describing a process for processing X3D data in a X3D browser; and

FIG. 4 illustrates X3D data processed by an X3D browser and displayed on a display window of a user's terminal in accordance with the present invention.

### DETAILED DESCRIPTION OF THE PREFERRED EMBODIMENTS

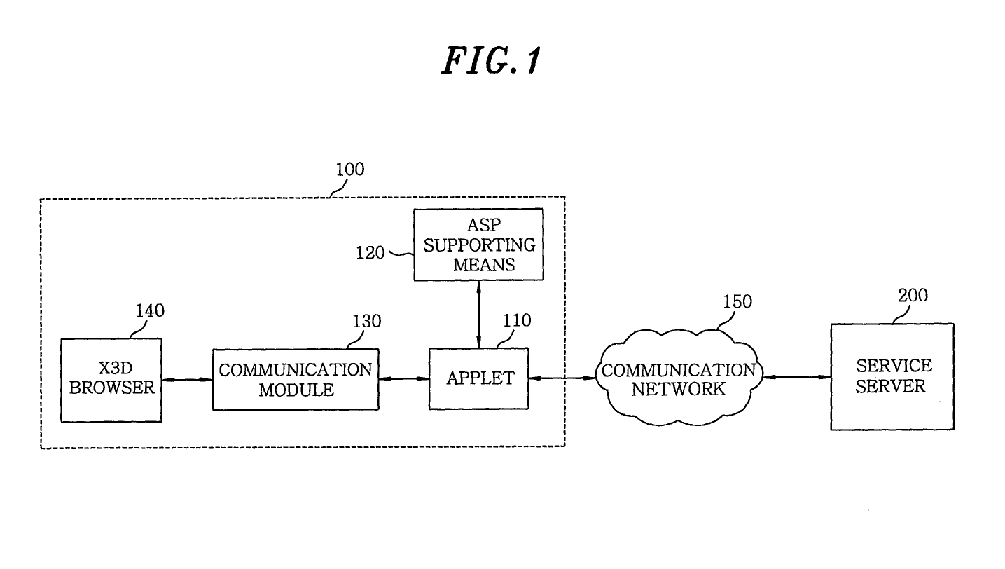

Referring to FIG. 1, there is provided a block diagram of a client/server system for implementing a 3D virtual reality in accordance with the present invention.

The client/server system includes a client 100, a communication network 150 and a service server 200. The client 100 has an applet 110, an ASP (active server page) supporting means 120, a communication module 130 and a X3D (extensible 3D) browser 140.

The service server 200 stores therein X3D data for use in implementing the virtual reality. Further, the service server 200 has a web server and a database server. The web server transmits through the communication network 150 the X3D data stored in the service server 200 to a terminal of a user who has accessed the service server 200. The database server stores therein history information of services offered by the service server 200 and login information of the user.

In case the service server 200 provides, e.g., a virtual shopping environment, the history information can be, for example, data of navigation paths through which the user navigate the 3D virtual reality, a list of items that the user purchased, etc. Installed in both the data server and the web server of the service server 200 is an applet for the communication with the applet 110 of the client 100.

The applet 110 of the client 100 communicates with the applet of the service server 200 to transceive X3D data. To be specific, the applet 110 requests to and receives from the service server 200 X3D data or certain information required for an event occurring on the X3D browser 140 which is displayed on a display window of the user's terminal, and, then, transfers through the communication module 130 the received data or information to the X3D browser 140.

The communication module 130 provides a communication with the service server 200 in response to an access request from the user, and serves as a mediator for supporting a communication between the ASP supporting means 120 and the X3D browser 140.

The X3D browser 140 is installed at a certain portion of the display window of the terminal to serve as a browsing means for displaying the 3D virtual reality. The X3D browser 140 receives through the communication module 130 the X3D data provided from the service server 200. Then, the X3D browser 140 constructs a scene graph by parsing the received X3D data and, subsequently, conducts a rendering of the scene graph and displays the result on the display window of the terminal. Further, the X3D browser 140 drives the applet 110 via the communication module 130 in order to request through the communication network 150 a data required for the event occurring in the virtual reality. Then, the X3D browser 140 processes the data sent from the service server 200 and displays the processed data on the display window of the terminal. In addition, the X3D browser 140 supports a graphic user interface that enables the user to move in the virtual reality, thereby allowing the user to navigate the virtual reality. Besides, the X3D browser 140 operates the applet 110 through the communication module 130 so as to obtain from the service server 200 information upon a selected item. The received selected-item information is displayed on a window of the X3D browser 140 by the ASP supporting means 120.

Still further, the X3D browser 140 cooperates with the ASP supporting means 120 to provide a logon, a session management, an avatar, a chatting and a mini-map service to the user.

The ASP supporting means 120 operates to process the event occurring in the virtual reality and is called through the communication module 130 and the applet 110 of the X3D browser 140.

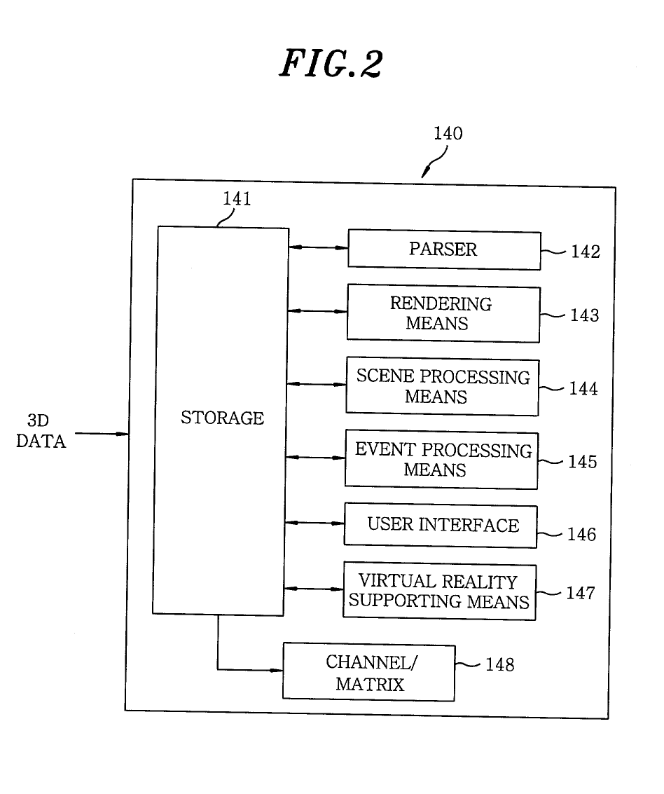

Functions of the X3D browser 140 will now be described in detail with reference to FIG. 2.

FIG. 2 is a block diagram of the X3D browser 140 in accordance with the present invention.

The X3D browser 140 includes a storage means 141, a parser 142, a rendering means 143, a scene processing means 144, an event processing means 145, a user interface 146, a virtual reality supporting means 147 and a channel/matrix 148. The storage means 141 has a VRML97 and an X3D library stored therein for processing the X3D data received from the service server 200. The parser 142 conducts a parsing of the X3D data sent from the service server 200 by using the libraries stored in the storage means 141. The rendering means 143 executes a rendering of the X3D data that has been analyzed by the parser 142. The scene processing means 144 updates the 3D scenes, keeping up with the changes caused by the user's navigation through the 3D virtual reality. The event processing means 145 processes the event occurring in the virtual reality and the user interface 146 supports the navigation performance of the user in the virtual reality, e.g., walking, looking, turning on a headlight, straightening, etc. The virtual reality supporting means 147 supports a special function in the virtual reality. The channel/matrix 148 processes the scene graph produced by the X3D browser 140 to be displayed on the display window of the terminal.

The user interface 146 supports various functions that enable the user to move in the virtual reality. Such functions include: a collision-detecting Walk function for allowing the user to navigate the inside space of the virtual reality without being hampered by a collision, an Examine function for enabling the user to see an object in various angles by revolving the object, a Slide function for changing a view point of the user in a vertical and a horizontal direction, a Look function for enabling the user to look around the virtual space in various angles from a current position, a Point function for approaching an object in the 3D virtual reality at a time when the user clicks the object, a Straighten function for straightening a user's posture, a Headlight function for producing an effect of throwing a headlight on the virtual reality, a Preview/Next view function for moving to a prior/next view point and an AutoNear function for preventing an object near the user to be culled by calculating the distance between the user and the object.

The user can navigate the virtual reality by using the above-described functions provided by the user interface 146.

The virtual reality supporting means 147 includes a user event processing unit for processing a user-defined event among a plurality of events occurring on a navigation window implemented by the X3D browser 140 and a mini-map management unit for managing a two-dimensional mini-map which is provided in order to allow the user to freely travel through a large-scaled virtual reality displayed on the navigation window.

The virtual reality supporting means 147 supports various functions including a function of reading information upon an object in the virtual reality and of detecting a 3D position by using the mini-map. The virtual reality supporting means 147 communicates with the ASP supporting means 120 to display the mini-map or an information window for showing the object information at an outside of the navigation window that visualizes the 3D virtual reality.

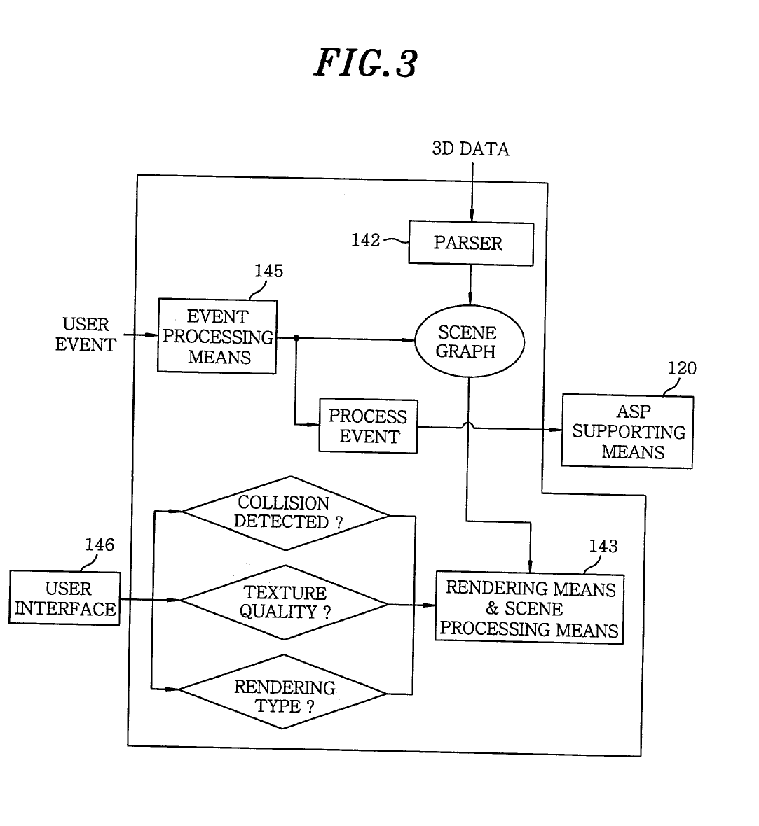

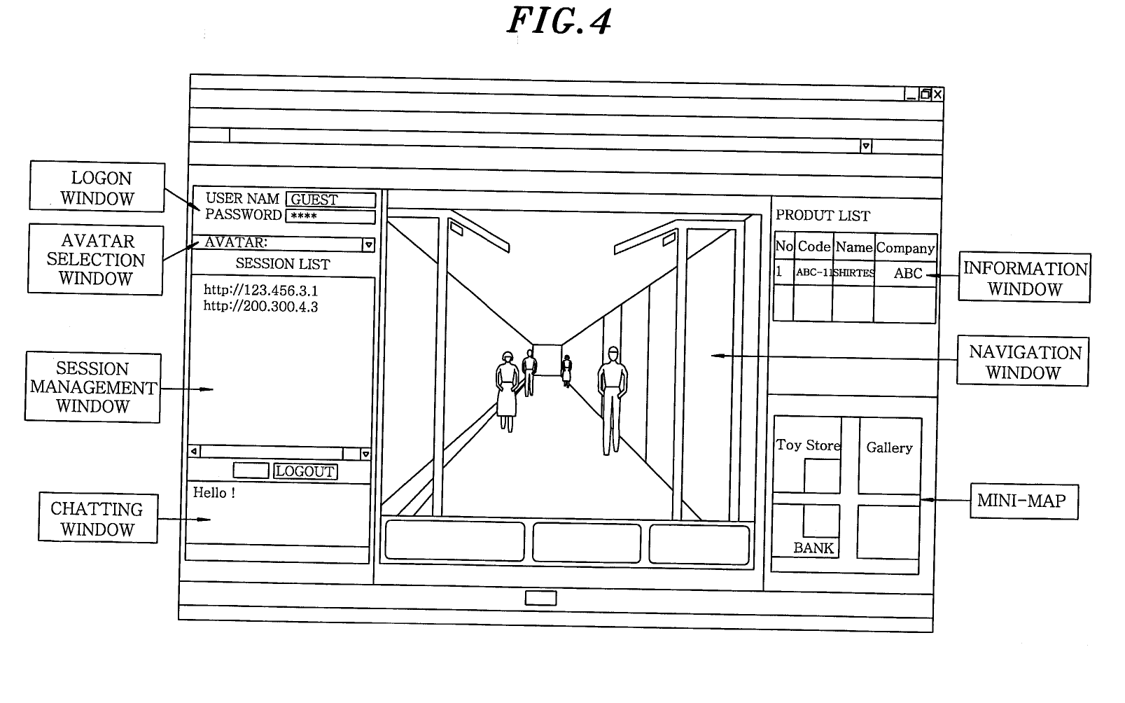

Referring to FIGS. 3 and 4, there is described a process for the X3D browser 140 implementing the 3D virtual reality by processing the X3D data transferred through the applet 110 and the communication module 130.

FIG. 3 is a flow chart for illustrating a process for the X3D browser 140 processing the X3D data and FIG. 4 shows an example of the X3D browser displayed on the display window of the user's terminal.

AS shown in FIG. 3, the applet 110 receives the X3D data transferred from the service server 200. The received X3D data is inputted to the X3D browser 140 through the communication module 130. Then, the parser 142 of the X3D browser 140 parses the received X3D data by using the libraries stored in the storage means 141 to construct a scene graph of the X3D data. Thereafter, the rendering means 134 renders the scene graph of the X3D data.

As shown in FIG. 4, the channel/matrix 148 receives the rendering-processed data to generate a scene data and displays the generated scene data by using the navigation window generated at a predetermined portion of the display window of the terminal.

The client system determines whether the user requests to search the virtual reality implemented by the X3D browser 140. If it is determined that the user intends to search the virtual reality, the user interface 146 updates the 3D scenes of the virtual reality, keeping up with the changes caused by the user's navigation through the virtual reality.

The user moves through the virtual reality implemented on the navigation window by using the Walk, the Look, the Examine, the Slide, the Straighten and the Headlight functions provided by the user interface 146. If the X3D data from the service server 200 is related to a shopping mall system, the user can enjoy shopping in the virtual reality by using the user interface 146.

The scene of the virtual reality is updated as follows. The user interface 145 processes the scene of the virtual reality displayed on the display window while detecting whether a collision occurs between plurality of users who are navigating the virtual reality. For example, if the collision occurs, the user interface 146 makes the scene to be rattled, thereby informing the user that the collision is made.

The user interface 146 of the X3D browser 140 provides a selection window for allowing the user to select a texture quality in the virtual reality and a rendering type for use in rendering the scene graph of the X3D data. Thus, the user can select the rendering type and the texture quality by using the selection window provided by the user interface 146, and the X3D browser 140 implements the virtual reality by using the selected rendering type and the texture quality.

The event processing means 145 checks various events occurring in the virtual reality implemented by the X3D browser 140. If an event is detected, the event processing means 145 receives the necessary data from the service server 200 through the applet 110 and the communication module 130.

Thereafter, in case the event is user-defined, the event processing means 145 sends the received data to the ASP supporting means 120. The ASP supporting means 120 generates an external window and processes the received data by using the generated external window.

If the event in the virtual reality requires only a scene update, the scene processing means 144 restructures the scene graph, and the restructured scene graph is displayed on the display window of the terminal after being rendered by the rendering means 143.

If the user requests information upon a certain object, e.g., information upon a merchandise in case the service server 200 provides a shopping mall environment, the virtual reality supporting means 147 of the X3D browser 140 communicates with the ASP supporting means 120 through the applet 110. Then, as shown in FIG. 4, the ASP supporting means 120 provides to the user the requested object information, which has been transferred from the service server 200 via the applet 110, by using the information window.

In addition to the information window for expressing the information of the object in the virtual reality, the X3D browser 140 also provides a logon window for managing user's logon, an avatar selection window for allowing the user to select his/her own character in the virtual reality, a session management window, a chatting window for allowing the user to chat with another user existing in the virtual reality and a mini-map information window for providing a two-dimensional mini-map for the 3D virtual reality.

The user can move to a desired position instantaneously by using the mini-map information window implemented by the X3D browser 140.

By using the above-described client system in accordance with the present invention, the user can experience a more real-world-like 3D virtual reality. Further, due to effective interactions between the user and the virtual reality system, it is facilitated for the user to, e.g., purchase merchandise in the virtual reality.

While the invention has been shown and described with respect to the preferred embodiments, it will be understood by those skilled in the art that various changes and modifications may be made without departing from the spirit and scope of the invention as defined in the following claims.

What is claimed is:

1. A client system for implementing a 3D virtual reality by using a X3D (extensible 3D) data provided from a service server, comprising:
an applet for communicating with the service server to receive the X3D data and transmit the received X3D data;
a communication module connected to the applet for providing a communication between the service server and a client; and
a browsing means for parsing the X3D data received through the communication module to construct a scene graph, conducting a rendering of the scene graph to have a predetermined form, and, then, displaying the scene graph on a display window of the client.

2. The system of claim 1, further comprising an ASP (active server page) supporting means for producing an external window to process the data which is sent from the service server via the applet according to a user event occurring in the virtual reality implemented by the browsing means.

3. The system of claim 1, wherein the browsing means includes:
a storage means for storing therein a VRML97 and/or a X3D library for processing the X3D data;
a parser for parsing the X3D data by using the VRML97 and/or the X3D library to construct a scene graph;
a rendering means for rendering the scene graph and, then, displaying the virtual reality on the display window of the client by using a plurality of channels/matrixes;
a user interface for supporting a user's navigation through the virtual reality;
a scene processing means for updating a scene of the virtual reality according to the user's navigation therethrough;
an event processing means for processing a user event occurring in the virtual reality; and
a virtual reality supporting means for supporting a function of searching for information upon an object in the virtual reality and of allowing an instantaneous movement across the virtual reality by using a two-dimensional mini-map prepared at an external window.

4. The system of claim 3, wherein the user interface supports Walk, Examine, Slide, Look, Point, Straighten, Headlight, Pre View/Next View, Auto Near functions in the virtual reality.

5. The system of claim 3, wherein the Walk function is capable of processing a collision that might occur while the user navigates the virtual reality.

6. A method for implementing a virtual reality in a client system by using a X3D data provided form a service server, comprising the steps of:
(a) parsing the received X3D data to construct a scene graph;
(b) conducting a rendering of the scene graph to have a predetermine form and, then, displaying the virtual reality on a navigation window;
(c) updating a scene of the virtual reality according to a user's navigation through the virtual reality displayed on the navigation window;
(d) determining whether an event occurs or not in response to an event information in the virtual reality displayed on the navigation window;
(e) receiving from the service server a data required for processing the event in the virtual reality based on the event determination and generating an external window to display the received data.

7. The method of claim 6, wherein the step (b) includes the stages of:
providing a selection window for allowing a user to select a texture quality and a rendering type for use in the client system to implement the virtual reality; and
constructing the scene of the virtual reality according to the selected texture quality and rendering type.

8. The method of claim 6, wherein, in the step (c), a collision between a user and an object in the virtual reality is detected during the user's navigation through the virtual reality displayed on the navigation window, and the scene of the virtual reality is updated according to the detected collision.

9. The method of claim 6, further comprising the steps of:
determining whether a user has requested information upon an object existing in the virtual reality;
receiving the object information from the service server based on the determination and displaying the received object information on an information window.

10. The method of claim 6, wherein when the navigation window is generated, also generated at an outside of the navigation window is a mini-map window for displaying a two-dimensional mini-map of the virtual reality implemented on the navigation window, the mini-map being used for an instantaneous movement across the virtual reality.
